(19) United States
(12) Patent Application Publication
(10) Pub. No.: US 2008/0318136 A1
(43) Pub. Date: Dec. 25, 2008

(54) NON-AQUEOUS ELECTROLYTES

(75) Inventors: Khalil Amine, Downers Grove, IL (US); Zonghai Chen, Bolingbrook, IL (US)

Correspondence Address: FOLEY & LARDNER LLP, 150 EAST GILMAN STREET, P.O. BOX 1497, MADISON, WI, 53701-1497, US

(73) Assignee: UChicago Argonne, LLC

(21) Appl. No.: 11/767,114

(22) Filed: Jun. 22, 2007

(51) Int. Cl. H01M 6/02

(52) U.S. Cl. 429/341

(57) ABSTRACT

Non-aqueous electrolytes have poly(ethyleneoxide) siloxane or poly(ethyleneoxide) phosphate, a salt, and an electrode stabilizing additive. Electrochemical cells using such electrolytes may be prepared and exhibit improved charge carrying capacity.

### GOVERNMENT RIGHTS

The United States Government has rights in this invention pursuant to Contract No. DE-AC02-06CH11357 between the United States Government and UChicago Argonne, LLC, representing Argonne National Laboratory.

### FIELD

The present invention generally relates to the composition of electrolytes and their use in electrochemical cells. Exemplary electrochemical cells include lithium ion rechargeable batteries and capacitors. The invention particularly relates to electrolyte systems using poly(ethyleneoxide) siloxanes and/or poly(ethyleneoxide) phosphates as the conducting phase.

### BACKGROUND

The increased demand for lithium batteries has resulted in research and development to improve the safety and performance of such batteries. Many lithium batteries employ organic carbonate electrolytes associated with high degrees of volatility, flammability, and chemical reactivity. To combat such disadvantages, electrochemical cells having solid polymer electrolyte (“SPE”) systems have been the subject of research and development. SPE systems have the potential to exhibit numerous advantages. Such advantages include high energy density, high electrolyte stability, the ability to be configured in nearly any shape since the electrolyte contains no liquid, potentially inexpensive, inherent safety characteristics versus liquid electrolytes, and an expansive market if successfully developed.

One type of SPE is based upon poly(ethyleneoxide) (“PEO”) polymers. Batteries based on PEO polymers have been investigated. Typically, the PEO used is a high molecular weight linear analog having a semicrystalline microstructure, which forms relatively strong, free-standing films at room temperature. The PEO system may be doped with lithium ions, from sources such as lithium trifluoromethansulfonimide [LiN(CF₃SO₃)₂]. The microcrystalline structure, while imparting the strength to the films, impedes the lithium ion transport, resulting in low ionic conductivities. As a result, such systems tend to require operation at elevated temperatures, above the melting point of the PEO polymer.

However, impediments to the successful implementation of SPE systems, at least for room temperature operation, has been the low ionic conductivity of the SPE, and a low working potential (e.g. <3.8 V vs. Li⁺/Li) of PEO polymers in the presence of transition metal oxides. For example, some batteries having solid polymer electrolytes are operated at elevated temperatures to increase the ionic conductivity of the electrolyte system. A variety of polysiloxane-based electrolytes have also been developed for use as solid electrolytes. However, the low ionic conductivity and/or cycling performance limits their use to applications that do not require high rate performance.

It has been widely demonstrated that the conductivity of the electrolytes can be improved by decreasing the molecular weight from pure solid phase to liquid phase. It has also been reported that the working window can be improved (e.g. up to 4.2 V vs. Li⁺/Li) by adding a silicon-based terminal group to the PEO chain (i.e. poly(ethyleneoxide) siloxanes). See K. Amine et. al. Electrochemical Communications 8, 429-433 (2006).

As above, some of the advantages of PEO-based electrolytes are that they have low flammability, are of a liquid state makes it easier to wet the electrodes in the electrochemical cells, and where silicon is used as a terminal group, the working potential of a cell may be increased to values approaching 4.2 V, and higher. Nevertheless, PEO siloxanes have their own drawbacks, in and of themselves. For example, they cannot provide a robust solid electrolyte interface (SEI) on the carbon surface of an electrode to effectively protect the lithiated-carbon from continuous reaction with the electrolyte components. This results in a fast capacity fade of electrochemical cells using such systems.

A new type of non-aqueous electrolyte, having one or more electrode stabilizing additives to effectively protect lithiated carbon are described. The electrolyte additives of the present invention form a robust SEI layer on the surface of carbon anodes.

### SUMMARY

In one aspect, a electrolyte comprises: a poly(ethyleneoxide) solvent comprising a silicon atom or a phosphorus atom, and one or more poly(ethyleneoxide) groups; a salt; and an electrode stabilizing additive. Thus, in some embodiments, the poly(ethyleneoxide) solvent is a poly(ethyleneoxide) siloxane, a poly(ethyleneoxide) phosphate, or a mixture of any two or more thereof.

In some embodiments, the poly(ethyleneoxide) solvent is a compound of Formula Ia, Ib, Ic, Id, Ie, If, Ig, or a mixture of any two or more thereof:

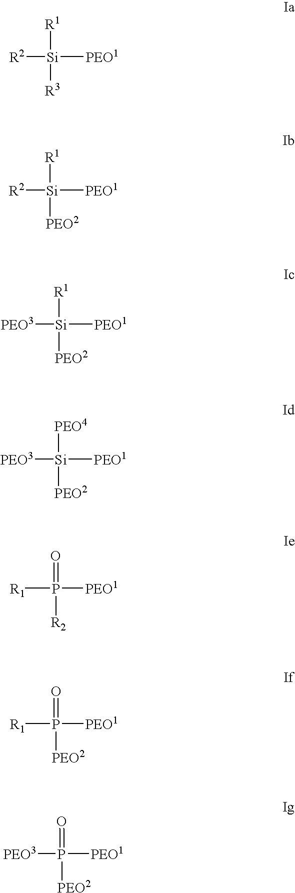

wherein

R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, IId, IIe, or IIf;

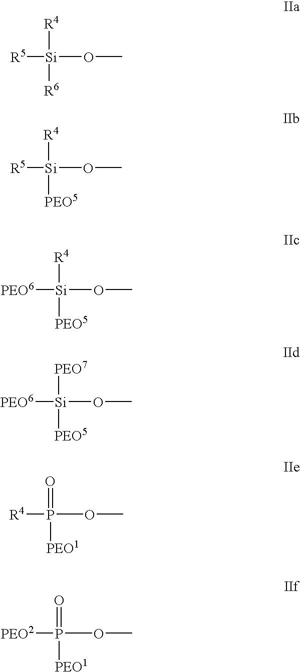

wherein,

R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and

PEO¹, PEO², PEO³, PEO⁴, PEO⁵, PEO⁶, and PEO⁷ are each independently a poly(ethyleneoxide) group; with the proviso that when the poly(ethyleneoxide)siloxane is a compound of Formula Ia and R¹ is a group of Formula IIa or IIb, then at least one of R², R³, R⁴, R⁵, and R⁶ is other than alkyl; and wherein the electrolyte is a non-aqueous electrolyte.

In some embodiments, the poly(ethyleneoxide) solvent is a compound of Formula Ib, Ic, Id, or a mixture thereof.

In some embodiments, PEO¹, PEO², PEO³, and PEO⁴ are each independently represented by Formula IIIa or IIIb;

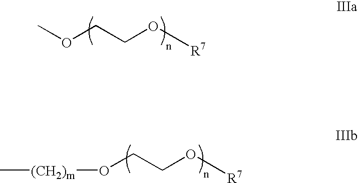

wherein R⁷ is a hydrogen, a substituted or unsubstituted alkyl group having from 1 to 12 carbon atoms, a substituted or unsubstituted alkenyl group having from 2 to 12 carbon atoms, or a group of Formula IV;

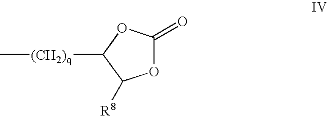

R⁸ is hydrogen, a substituted or unsubstituted alkyl group having from 1 to 12 carbon atoms, or a substituted or unsubstituted alkenyl group having from 2 to 12 carbon atoms; m represents a whole number from 1 to 8, n represents a whole number from 0 to 20, and q represents a whole number from 0 to 8.

In other embodiments, the poly(ethyleneoxide) solvent comprises: a compound of Formula Ie, If, Ig, or a mixture of any two or more thereof; or a mixture of the compound of Formula Ie, If, Ig, or a mixture of any two or more thereof with a compound of Formula Ia, Ib, Ic, Id, or a mixture of any two or more thereof.

In other embodiments, at least one of R₁, R₂, or R₃ is a group of Formula IIa, IIb, IIc, or IId.

In some embodiments, the electrolyte comprises a siloxanyl carbonate co-solvent. For example, in such embodiments, the co-solvent is 1-[1-trimethylsiloxanylethyl]ethylene carbonate.

In some embodiments, the salt is a lithium salt selected from the group consisting of LiClO₄, LiBF₄, LiAsF₆, LiPF₆, Li[PF₂(C₂O₄)₂], Li[PF₄(C₂O₄)], Li[CF₃SO₃], Li[N(CF₃SO₂)₂], Li[C(CF₃SO₂)₃], Li[N(SO₂C₂F₅)₂], a lithium alkyl fluorophosphate, Li[B(C₂O₄)₂], Li[BF₂(C₂O₄)], and a mixture of any two or more of thereof. In other embodiments, the salt is a tetraalkylammonium salt selected from the group consisting of [NR¹⁶₄][CF₃SO₃], [NR¹⁶₄][N(CF₃SO₂)²⁻], [NR¹⁶₄][BF₄⁻], [NR¹⁶₄][PF₆⁻], [NR¹⁶₄][AsF₆⁻], and a mixture of any two or more of thereof, wherein each R¹⁶ is independently an alkyl having from 1 to 12 carbon atoms. In yet other embodiments, the salt may be a mixture of a lithium salt and a tetralkylammonium salt. The concentration of the salt may be from about 0.01 M to about 2.0 M.

In some embodiments, the electrode stabilizing additive is a carbonate selected from the group consisting of ethylene carbonate, propylene carbonate, diethyl carbonate, dimethyl carbonate, ethyl methyl carbonate, and a mixture of two or more hereof. In some embodiments, the concentration of the carbonate in the electrolyte is 0.001 wt % to 50 wt %.

In some embodiments, the electrode stabilizing additive can be oxidized or polymerized on the surface of positive electrodes. In other such embodiments, the electrode stabilizing additive can be reduced or polymerized on the surface of negative electrodes.

In some embodiments, the electrode stabilizing additive is pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methyl pyrrole, naphthalene, 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9-diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9-diethylidene-1,5,7,11-tetraoxaspiro[5.5]undecane, or a mixture of any two or more thereof.

In some embodiments, the electrode stabilizing additive is a substituted or unsubstituted spirocyclic hydrocarbon containing at least one oxygen atom and at least one alkenyl or alkynyl group.

In some embodiments, the electrode stabilizing additive is a compound of Formula IX:

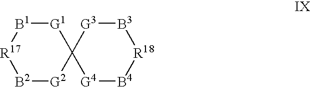

wherein

B¹, B², B³, and B⁴ are each independently O or CR¹⁹R²⁰; provided that B¹ is not O when G¹ is O, B² is not O when G² is O, B³is not O when G³is O, and B⁴is not O when G⁴ is O;

G¹, G², G³, and G⁴ are each independently O or CR¹⁹R²⁰; provided that G¹ is not O when B¹ is O, G² is not O when B² is O, G³ is not O when B³ is O, and G⁴ is not O when B⁴ is O;

R¹⁷ and R¹⁸ are each independently a substituted or unsubstituted divalent alkenyl or alkynyl group;

R¹⁹ and R²⁰ at each occurrence are independently H, F, Cl, a substituted or an unsubstituted alkyl, alkenyl, or alkynyl group.

In some embodiments, the electrode stabilizing additive is 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9-diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9-diethylidene-1,5,7,11-tetraoxaspiro[5.5]undecane, or a mixture of any two or more thereof.

In some embodiments, the at least one salt is not Li[PF₂(C₂O₄)₂] or Li[PF₄(C₂O₄)], and the electrode stabilizing additive is Li[PF₂(C₂O₄)₂], Li[PF₄(C₂O₄)], or a mixture thereof.

In some embodiments, the electrode stabilizing additive is present from about 0.001 wt % to about 10 wt %.

In some embodiments, the electrode stabilizing additive is an anion receptor. In some such embodiments, the anion receptor is a Lewis acid. In other such embodiments, the anion receptor is a borane, a boronate, a borate, a borole, or a mixture of any two or more thereof. In other such embodiments, the anion receptor is tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, 2-(2,4-difluorophenyl)-4-fluoro-1,3,2-benzodioxaborole, 2-(3-trifluoromethyll phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl)pentafluorophenylboronate, or a mixture of any two or more thereof.

In some embodiments, each anion receptor is present at a concentration of about 0.001 to about 10 wt %.

In another aspect, an electrochemical cell comprises a electrolyte embodied herein, and an electrode.

In some embodiments, the electrochemical cell is a lithium-ion rechargeable cell. In other embodiments, the electrochemical cell is a capacitor. In other such embodiments, the capacitor is a double layer electrochemical capacitor.

### BRIEF DESCRIPTION OF THE DRAWINGS

FIGS. 1 are graphs of the (a) initial differential capacity profile, and (b) capacity retention of a Li/MCMB cell for a comparative example.

FIGS. 2 are graphs of the (a) initial differential capacity profile, and (b) capacity retention of a Li/MCMB cell for a comparative example.

FIGS. 3 are graphs of the (a) initial differential capacity profile, and (b) capacity retention of a Li/MCMB cell for one of the inventive electrolytes.

FIGS. 4 are graphs of the (a) initial differential capacity profile, and (b) capacity retention of a Li/MCMB cell for one of the inventive electrolytes.

FIGS. 5 are graphs of the (a) initial differential capacity profile, and (b) capacity retention of a Li/MCMB cell for one of the inventive electrolytes.

### DETAILED DESCRIPTION

In one aspect, poly(ethyleneoxide) electrolytes are provided for use in battery applications. Such electrolytes comprise a poly(ethyleneoxide) solvent, a salt, and an electrode stabilizing additive. In some embodiments, the poly(ethyleneoxide) solvent is a poly(ethyleneoxide) (‘PEO’) solvent having at least one silicon or phosphorus atom, that readily dissolves electrolyte additives such as tetralkylammonium or lithium salts. Such electrolytes are non-aqueous electrolytes. Electrochemical devices prepared using the electrolytes and methods of preparing or assembling electrochemical cells are provided.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

MCMB is an abbreviation for mesocarbon microbeads.

SEI is an abbreviation for solid electrolyte interface. An SEI is defined herein as organic-inorganic composite thin film deposited on the surface of electrode materials.

TFSI is an abbreviation for bis(trifluorosulfonyl)imide.

In general, “substituted” refers to an alkyl or alkenyl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched alkyl groups having from 1 to 12 carbon atoms or, in some embodiments, from 1 to 8, 1 to 6, or 1 to 4 carbon atoms. Alkyl groups further include cycloalkyl groups as defined below. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 12 carbon atoms in some embodiments, from 2 to 10 carbon atoms in other embodiments, and from 2 to 8 carbon atoms in other embodiments. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

The electrolytes embodied herein, comprise a poly(ethyleneoxide) solvent, such as a poly(ethyleneoxide) siloxane (PEO siloxane) solvent or a poly(ethyleneoxide) phosphate (PEO phosphate) solvent for dissolution of a salt for ion transport and an electrode stabilizing additive to protect an electrode(s).

PEO siloxanes and PEO phosphates have one or more PEO groups attached to the silicon atom. PEO siloxanes and PEO phosphates readily dissolve electrolyte additives such as tetralkylammonium or lithium salts, and have the required low viscosity to transport the lithium ions. PEO siloxanes generally have PEO as side chains linked to the silicon or phosphorus atom. For example, PEO siloxanes may be generally described by Formulas Ia-Id and PEO phosphates may be generally described by Formulas Ie-g:

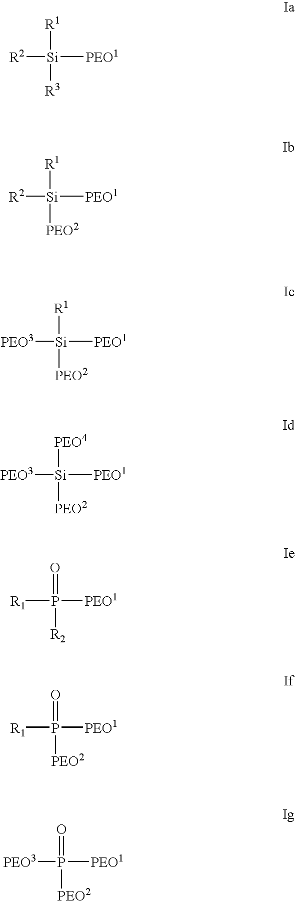

wherein R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, IId, IIe, or IIf;

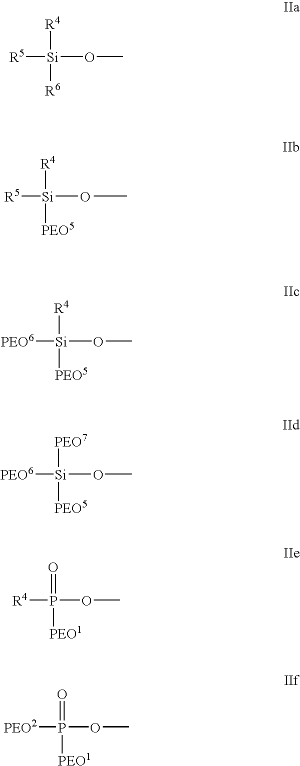

wherein, R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and PEO¹, PEO², PEO³, PEO⁴, PEO⁵, PEO⁶, and PEO⁷ are each independently a poly(ethyleneoxide) group.

In some embodiments, the poly(ethyleneoxide) siloxane is a compound of Formula Ib, Ic, Id, or a mixture of any two or more thereof. In other embodiments, where the poly(ethyleneoxide) siloxane is a compound of Formula Ia and R¹ is a group of Formula IIa or IIb, then at least one of R², R³, R⁴, R⁵, and R⁶ is other than alkyl.

In some embodiments, the electrolyte comprises a poly(ethyleneoxide) siloxane). In some other embodiments, the electrolyte comprises a poly(ethyleneoxide) phosphate. In other embodiments, the electrolyte comprises a poly(ethyleneoxide) phosphate in mixture with a poly(ethyleneoxide) siloxane. In some embodiments, the electrolytes are not gelled electrolytes.

In some embodiments, PEO¹, PEO², PEO³, PEO⁴, PEO⁵, PEO⁶, and PEO⁷ are each independently represented by Formula IIIa or IIIb;

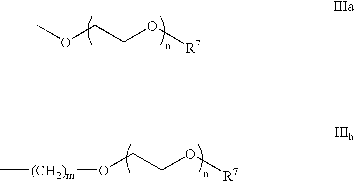

where R⁷ is a hydrogen, a substituted or unsubstituted alkyl group having from 1 to 12 carbon atoms, a substituted or unsubstituted alkenyl group having from 2 to 12 carbon atoms, or a group of Formula IV;

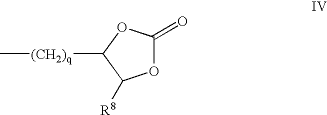

where R⁸ is hydrogen, a substituted or unsubstituted alkyl group having from 1 to 12 carbon atoms, or a substituted or unsubstituted alkenyl group having from 2 to 12 carbon atoms; m represents whole number from 1 to 8, n represents whole number from 0 to 20, and q represents whole number from 0 to 8. An exemplary poly(ethylene oxide) siloxane is 2-[2-[2-methoxy]ethoxy]ethoxy trimethyl silane (1NM2), the structure of which is shown as Formula V:

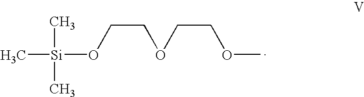

Another exemplary poly(ethylene oxide) siloxane is 2-[2-[2-[2-methoxy]ethoxy]ethoxy]ethoxy trimethyl silane (1NM3), the structure of which is shown as Formula VI:

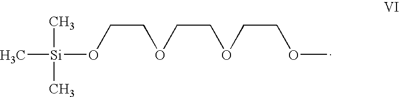

The concentration of the poly(ethyleneoxide) siloxane and/or phosphate may vary across a wide range of concentrations, depending upon the desired characteristics of the electrolyte. In some embodiments, the poly(ethyleneoxide) siloxane and/or phosphate is present from about 5 wt % to about 95 wt %, wherein the wt % is calculated on the total weight of the poly(ethyleneoxide) siloxane and/or phosphate, the salt, and the electrode stabilizing additive. In some such embodiments, the poly(ethyleneoxide) siloxane and/or phosphate is present from about 30 wt % to about 95 wt %. In other such embodiments, the poly(ethyleneoxide) siloxane and/or phosphate is present from about 50 wt % to about 80 wt %.

Properties of the electrolyte, such as viscosity, conductivity, and salt dissolution capacity, may be varied by the addition of a co-solvent to the poly(ethyleneoxide) siloxane and/or phosphate. For example, and without limitation, siloxanyl carbonates may be used as a co-solvent in such electrolytes. Exemplary siloxanyl carbonates include, but are not limited to, 1-[1-trimethylsiloxanyl-ethyl]-ethylene carbonate (1NMC) the structure of which is shown as Formula VII:

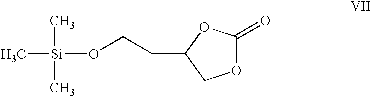

In some other embodiments, the content of the co-solvent is from about 0.1 wt % to about 80 wt %, wherein the wt % is calculated on the total weight of the at least one poly(ethyleneoxide) siloxane and/or phosphate, the salt, and the electrode stabilizing additive. In some such embodiments, the content of the co-solvent is from about 1 wt % to about 70 wt %, from about 2 wt % to about 60 wt %, from about 3 wt % to about 50%, or from about 4 wt % to about 40 wt %.

Salts suitable for use in the electrolytes are not particularly limited, as long as the salt dissolves in the PEO siloxane and/or phosphate, and the salt serves as an electrolyte for an electrochemical device including batteries and capacitors. Suitable salts include, but are not limited to, tetraalkylammonium (R¹⁶₄N⁺) salts of CF₃SO₃⁻, N(CF₃SO₂)²⁻, BF₄⁻, PF₆⁻, AsF₆⁻, or a mixture of any two or more thereof. In such embodiments, R¹⁶ is an alkyl group having from 1 to 12 carbon atoms. Other salts include lithium salts such as LiClO₄, LiBF₄, LiAsF₆, LiPF₆, Li[PF₂(C₂O₄)₂], Li[PF₄C₂O₄], Li[CF₃SO₃], Li[N(CF₃SO₂)₂], Li[C(CF₃SO₂)₃], Li[N(SO₂C₂F₅)₂], lithium alkyl fluorophosphates, Li[B(C₂O₄)₂] (‘LiBOB’), Li[BF₂(C₂O₄)] (‘LiDFOB’), or a mixture of any two or more thereof. Lithium (chelato)borates such as Li[B(C₂O₄)₂] and Li[BF₂(C₂O₄)], or lithium (chelato)phosphates such as Li[PF₂(C₂O₄)₂] and Li[PF₄(C₂O₄)] may also be used as the salt, or as an electrode stabilizing additive. Thus, in some embodiments, the salt may be other than Li[B(C₂O₄)₂], Li[BF₂(C₂O₄)], Li[PF₄(C₂O₄)] or Li[PF₂(C₂O₄)₂], and the electrolyte may include, as a electrode stabilizing additive, Li[B(C₂O₄)₂], Li[BF₂(C₂O₄)], Li[PF₂(C₂O₄)₂], Li[PF₄(C₂O₄)], or a mixture of any two or more thereof, at, e.g., from about 0.001 wt % to about 10 wt %.

The salt concentration may be optimized for current carrying capacity in the electrolytes. For example, the salt may be present at from about 0.01 M to about 1.5 M, from about 0.05 M to about 1.2 M, or from about 0.4 M to about 1.0 M. If the concentration of the lithium salt is less than 0.01 M, the ionic conductivity of the resulting non-aqueous electrolyte is significantly decreased because of an inadequate number of carrier ions are in the electrolyte.

Electrolytes embodied herein may comprise an electrode stabilizing additive to protect an electrode from degradation. For example, co-pending U.S. patent application Ser. No. 10/857,365, filed on May 28, 2004; Ser. No. 11/297120 filed on Dec. 8, 2005; and Ser. No. 11/338902 filed on Jan. 24, 2006, list a number of stabilizing additives that may be used in the present electrolytes. Electrode stabilizing additives can be reduced or polymerized on the surface of a negative electrode to form a passivation film on the surface of negative electrode. Likewise, other electrode stabilizing additives can be oxidized or polymerized on the surface of the positive electrode to form a passivation film on the surface of the positive electrode. In some embodiments electrolytes of the invention further include mixtures of the two types of electrode stabilizing additives. The additives are typically present at a concentration of about 0.001 to about 10 wt %.

Representative electrode stabilizing additives include, but are not limited to, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methyl pyrrole, naphthalene, 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9diethylidene-1,5,7,11-tetraoxaspiro[5.5]undecane, or a mixture of any two or more thereof.

Other electrode stabilizing additives include, but are not limited to, substituted or unsubstituted spirocyclic hydrocarbons containing at least one oxygen atom and at least one alkenyl or alkynyl group. For example, such spirocyclic hydrocarbons include those having Formula IX:

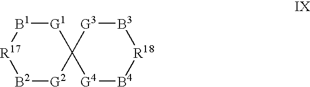

wherein, B¹, B², B³, and B⁴ are independently O or CR¹⁹R²⁰; provided that B¹ is not O when G¹ is O, B² is not O when G² is O, B³ is not O when G³ is O, and B⁴ is not O when G⁴ is O; G¹, G², G³, and G⁴ are independently O or CR¹⁹R²⁰; provided that G¹ is not O when B¹ is O, G² is not O when B² is O, G³ is not O when B³ is O, and G⁴ is not O when B⁴ is O; R¹⁷ and R¹⁸ are independently a substituted or unsubstituted divalent alkenyl or alkynyl group; R¹⁹ and R²⁰ at each occurrence are independently H, F, Cl, a substituted or an unsubstituted alkyl, alkenyl, or alkynyl group.

Representative examples of Formula IX include, but are not limited to, 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9diethylidene-1,5,7,11-tetraoxaspiro[5.5]undecane, or a mixture of any two or more thereof.

Other suitable electrode stabilizing additives include, but are not limited to, those electrode stabilizing additives that reduce the interfacial impedance of the electrochemical devices. For example, such additives may be an anion receptor, including those having Formula X:

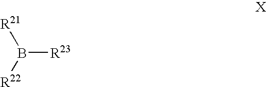

wherein, R²¹, R²², and R²³ are independently halogen, alkyl, aryl, halogen-substituted alkyl, halogen-substituted aryl, or OR; or any two of R²¹, R²², R²³, and R²⁴, together with the atoms to which they are attached, form a heterocyclic ring having 5-9 members, and R²⁴ is at each occurrence independently alkyl, aryl, halogen-substituted alkyl, or halogen-substituted aryl. In some such embodiments, R²¹, R²², and R²³ are independently halogen, alkyl, aryl, halogen-substituted alkyl, or halogen-substituted aryl; or any two of R²¹, R²², and R²³, together with the boron to which they are attached, form a heterocyclic ring having 5-9 members.

Representative anion receptors include, but are not limited to, tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a mixture of any two or more thereof. Further suitable additives include 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl)pentafluorophenylboronate, or a mixture of any two or more thereof.

Electrochemical cells comprising the electrolytes and at least one electrode may be prepared. In some embodiments, the electrochemical cell is a lithium-ion rechargeable cell. In other embodiments, the electrochemical cell is a capacitor. In other such embodiments, the capacitor is a double layer electrochemical capacitor.

One skilled in the art will readily realize that all ranges and ratios discussed can and do necessarily also describe all subranges and subratios therein for all purposes and that all such subranges and subratios also form part and parcel of this invention. Any listed range or ratio can be easily recognized as sufficiently describing and enabling the same range or ratio being broken down into at least equal halves, thirds, quarters, fifths, tenths, etc. As a non-limiting example, each range or ratio discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention will be better understood by reference to the following examples which are intended for purposes of illustration and are not intended to nor are to be interpreted in any way as limiting the scope of the present invention, which is defined in the claims appended hereto.

### EXAMPLES

### Comparative Example 1

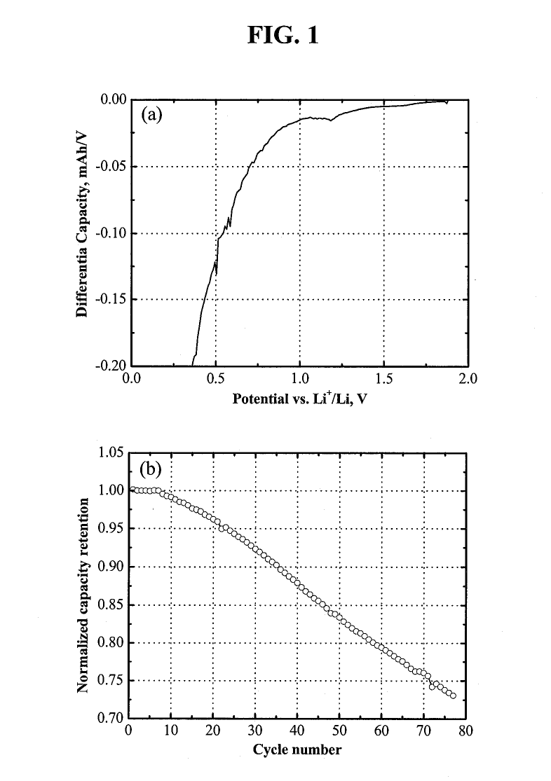

FIG. 1(a) shows the initial differential capacity profile of a Li/MCMB cell prepared with 1.0 M LiTFSI in 1NM2. Only a small peak was observed at about 1.2 V vs. Li⁺/Li during the initial discharge process. FIG. 1(b) shows the discharge capacity of the same Li/MCMB cell as a function of the cycle number. Almost 30% of the initial capacity was lost after about 80 cycles at 25° C. Without being bound by theory, the loss is believed to be due to the lack of an SEI to protect the MCMB negative electrode.

### Comparative Example 2

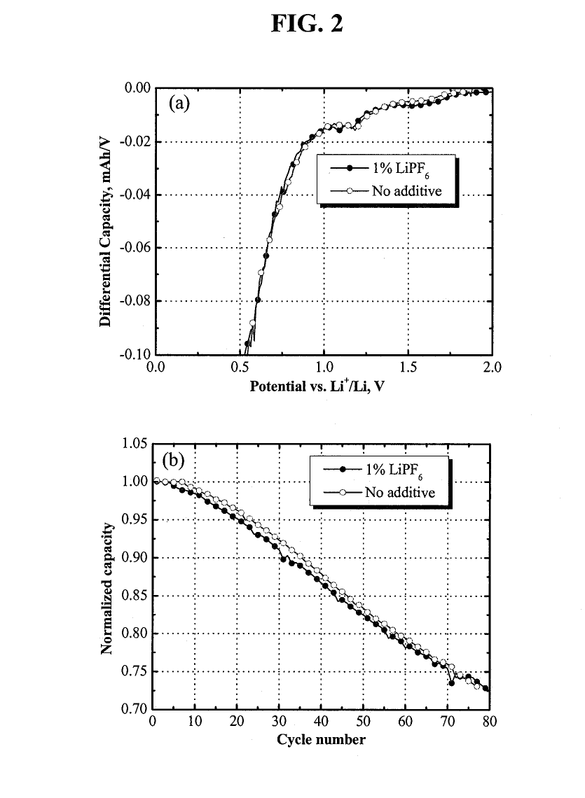

FIG. 2(a) shows the initial differential capacity profile of a Li/MCMB cell prepared with 1.0 M LiTFSI in 1NM2 with 1 wt % LiPF₆. As a comparison, the differential capacity profile of the cell with LiPF₆ from Comparative Example 1 is also shown as the line with open circles. No difference was observed by adding 1 wt % LiPF₆ to the electrolyte. FIG. 2(b) shows the discharge capacity of the Li/MCMB cell as a function of the cycle number. The addition of 1 wt % LiPF₆ does not have a noticeable impact on the capacity retention of the cell.

### Example 4

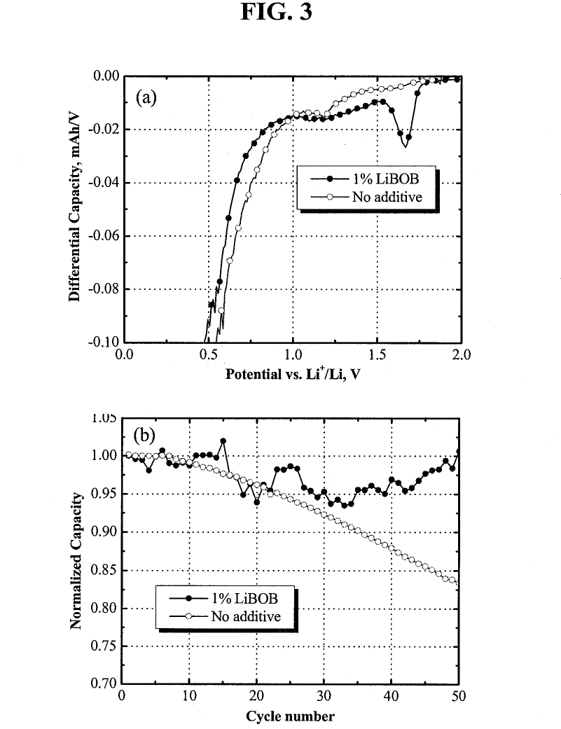

FIG. 3(a) shows the initial differential capacity profile of a Li/MCMB cell prepared with 1.0 M LiTFSI in 1NM2 with 1 wt % LiBOB. As a comparison, the differential capacity profile of the cell with LiPF₆ from Comparative Example 1 is designated by the open circles. The additional peak at approximately 1.6 V vs. Li⁺/Li is attributed to the passivation of the MCMB electrode by LiBOB. FIG. 3(b) shows improvement in the capacity retention of the cell from the addition of 1 wt % LiBOB. However, the capacity remains sensitive to temperature fluctuations due to the high-resistance film formed by the LiBOB.

### Example 5

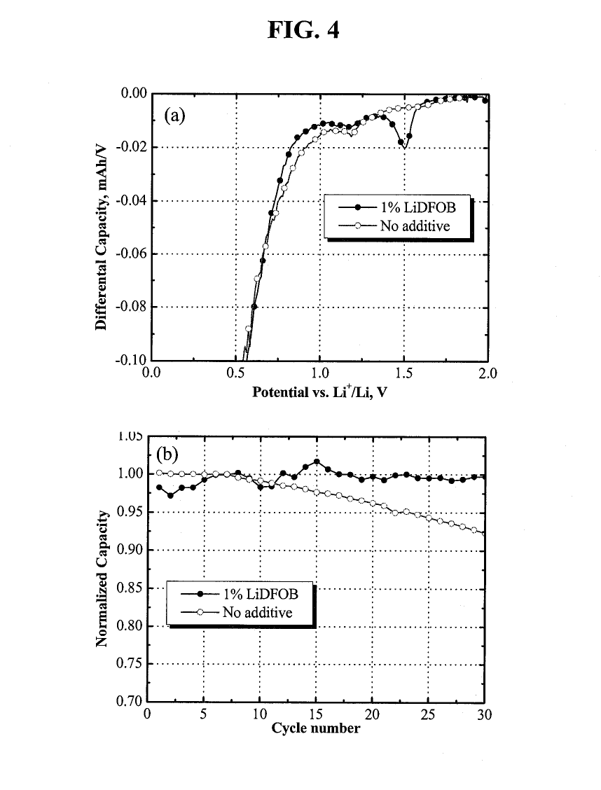

FIG. 4(a) shows the initial differential capacity profile of a Li/MCMB cell prepared with 1.0 M LiTFSI in 1NM2 with 1 wt % LiDFOB. As a comparison, the differential capacity profile of the cell with LiPF₆ from Comparative Example 1 is designated by the open circles. The additional peak at approximately 1.5 V vs. Li⁺/Li is attributed to the passivation of the MCMB electrode by LiDFOB. FIG. 4(b) shows improvement of the capacity retention of the cell due to the addition of the LiDFOB. The capacity remains sensitive to temperature fluctuations due to the high-resistance film formed by LiDFOB.

### Example 6

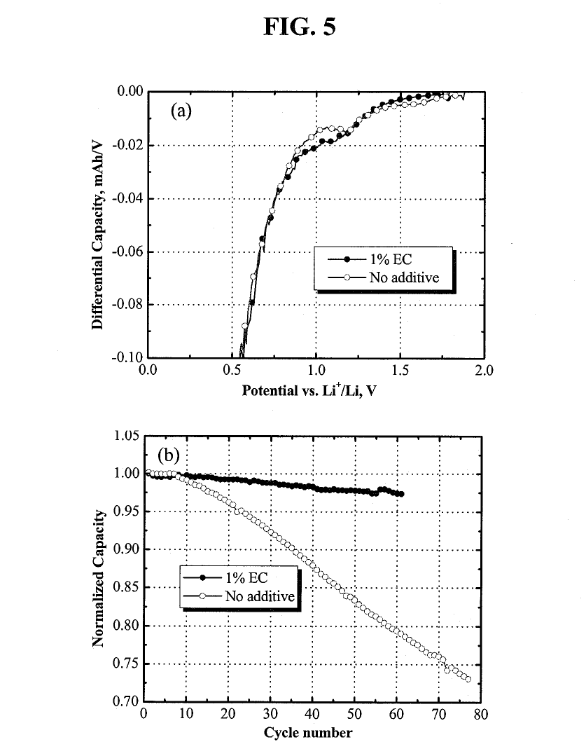

FIG. 5(a) shows the initial differential capacity profile of a Li/MCMB cell prepared with 1.0 M LiTFSI in 1NM2 with 1 wt % ethylene carbonate (EC). As a comparison, the differential capacity profile of the cell with LiPF₆ from Comparative Example 1 is designated by the open circles. No major difference on the differential capacity profile were observed. However, FIG. 5(b) shows that the capacity retention of the cell was dramatically improved by the addition of 1 wt % EC.

While several, non-limiting examples have been illustrated and described, it should be understood that changes and modifications can be made therein in accordance with ordinary skill in the art without departing from the invention in its broader aspects as defined in the following claims.

What is claimed is:

1. An electrolyte comprising:
a poly(ethyleneoxide) solvent comprising
a silicon atom and/or a phosphorus atom; and
one or more poly(ethyleneoxide) groups;
a salt; and
an electrode stabilizing additive;
wherein the electrolyte is not a gelled electrolyte; and
the poly(ethyleneoxide) solvent is a compound of Formula Ia, Ib, Ic, Id, Ie, If, Ig, or a mixture of any two or more thereof: 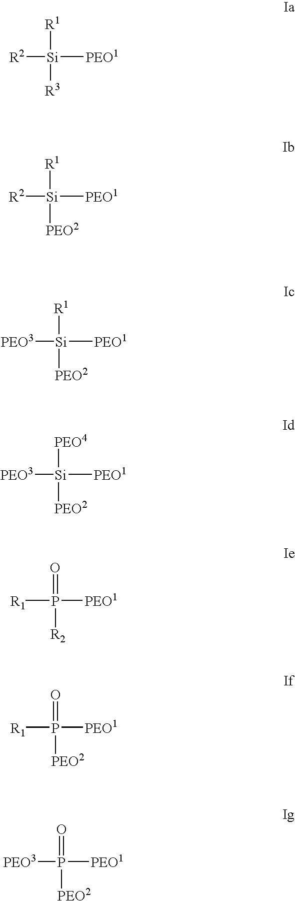
wherein
R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, IId, IIe, or IIf; 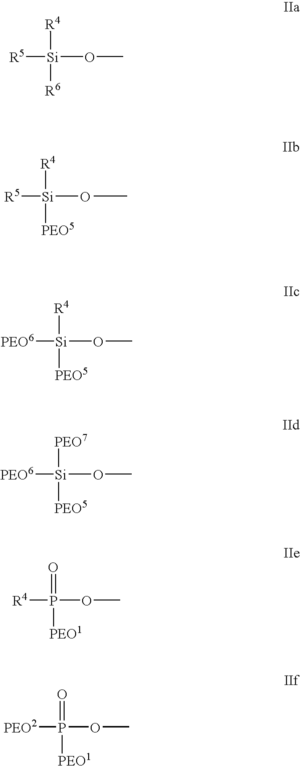
wherein,
R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and
PEO¹, PEO², PEO³, PEO⁴, PEO⁵, PEO⁶, and PEO⁷ are each independently a poly(ethyleneoxide) group; with the proviso that when the poly(ethyleneoxide) siloxane is a compound of Formula Ia and R¹ is a group of Formula IIa or IIb, then at least one of R², R³, R⁴, R⁵, and R⁶ is other than alkyl; and
wherein the electrolyte is a non-aqueous electrolyte.

2. The electrolyte of claim 1, wherein the poly(ethyleneoxide) solvent is a compound of Formula Ib, Ic, Id, or a mixture of any two or more thereof.

3. The electrolyte of claim 1, wherein the electrolyte is not gelled.

4. The electrolyte of claim 1, wherein PEO¹, PEO², PEO³, and PEO⁴ are each independently represented by Formula IIIa or IIIb; 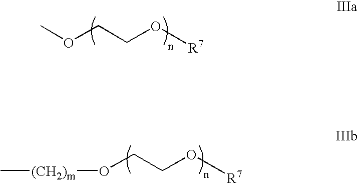
wherein
R⁷ is a hydrogen, a substituted or unsubstituted alkyl group having from 1 to 12 carbon atoms, a substituted or unsubstituted alkenyl group having from 2 to 12 carbon atoms, or a group of Formula IV; 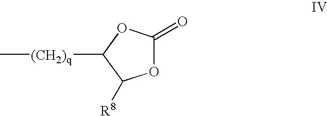
R⁸ is hydrogen, a substituted or unsubstituted alkyl group having from 1 to 12 carbon atoms, or a substituted or unsubstituted alkenyl group having from 2 to 12 carbon atoms;
m represents a whole number from 1 to 8,
n represents a whole number from 0 to 20, and
q represents a whole number from 0 to 8.

5. The electrolyte of claim 1, wherein the poly(ethyleneoxide) solvent comprises:
a compound of Formula Ie, If, Ig, or a mixture of any two or more thereof; or
a mixture of the compound of Formula Ie, If, Ig, or a mixture of any two or more thereof with a compound of Formula Ia, Ib, Ic, Id, or a mixture of any two or more thereof.

6. The electrolyte of claim 1, wherein at least one of R₁, R₂, or R₃ is a group of Formula IIa, IIb, IIc, or IId.

7. The electrolyte of claim 1, further comprising a siloxanyl carbonate co-solvent.

8. The electrolyte of claim 7, wherein the co-solvent is 1-[1-trimethylsiloxanylethyl]ethylene carbonate.

9. The electrolyte of claim 1, wherein the poly(ethyleneoxide) siloxane is 2-[2-[2-[2-methoxy]ethoxy]ethoxy]ethoxy trimethyl silane, 2-[2-[2-methoxy]ethoxy]ethoxy trimethyl silane, or a mixture thereof.

10. The electrolyte of claim 1, wherein the poly(ethyleneoxide) siloxane is present from about 5 wt % to about 95 wt %, wherein the wt % is calculated on the total weight of the poly(ethyleneoxide) siloxane, the salt, and the electrode stabilizing additive.

11. The electrolyte of claim 1, wherein the salt is selected from the group consisting of:
a lithium salt selected from the group consisting of LiClO₄, LiBF₄, LiAsF₆, LiPF₆, Li[PF₂(C₂O₄)₂], Li[PF₄(C₂O₄)], Li[CF₃SO₃], Li[N(CF₃SO₂)₂], Li[C(CF₃SO₂)₃], Li[N(SO₂C₂F₅)₂], a lithium alkyl fluorophosphate, Li[B(C₂O₄)₂], Li[BF₂(C₂O₄)], and a mixture of any two or more of thereof;
a tetraalkylammonium salt selected from the group consisting of [NR¹⁶₄][CF₃SO₃], [NR¹⁶₄][N(CF₃SO₂)²⁻], [NR¹⁶₄][BF₄⁻], [NR¹⁶₄][PF₆⁻], [NR¹⁶₄][AsF₆⁻], and a mixture of any two or more of thereof, wherein each R¹⁶ is independently an alkyl having from 1 to 12 carbon atoms; and
a mixture of any two or more thereof.

12. The electrolyte of claim 11, wherein the concentration of the tetraalkylammonium salt is from about 0.01 M to about 2.0 M.

13. The electrolyte of claim 1, wherein the electrode stabilizing additive can be oxidized or polymerized on the surface of a positive electrode, or can be reduced or polymerized on the surface of a negative electrode.

14. The electrolyte of claim 13, wherein the stabilizing additive that can be reduced or polymerized on the surface of the negative electrode is selected from the group consisting of quinoline, vinyl quinoline, indole, vinyl indole, triethanolamine, imidazole, vinyl imidazole, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methyl pyrrole, naphthalene, 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9-diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9-diethylidene-1,5,7,11-tetraoxaspiro[5.5]undecane, and a mixture of any two or more thereof.

15. The electrolyte of claim 14, wherein the electrode stabling additive is a compound of Formula IX: 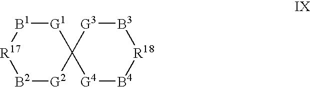
wherein
B¹, B², B³, and B⁴ are independently O or CR²²R²³; provided that B¹ is not O when G¹ is O, B² is not O when G² is O, B³ is not O when G³ is O, and B⁴ is not O when G⁴ is O;
G¹, G², G³, and G⁴ are independently O or CR²²R²³; provided that G¹ is not O when B¹ is O, G² is not O when B² is O, G³ is not O when B³ is O, and G⁴ is not O when B⁴ is O;
R²⁰ and R²¹ are independently a substituted or unsubstituted divalent alkenyl or alkynyl group;
R²² and R²³ at each occurrence are independently H, F, Cl, a substituted or an unsubstituted alkyl, alkenyl, or alkynyl group.

16. The electrolyte of claim 15, wherein the compound of Formula IX is selected from the group consisting of 3,9-divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9-diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9-dimethylene-1,5,7,11-tetraoxaspiro[5.5]undecane, 3,9-diethylidene-1,5,7,11-tetraoxaspiro[5.5]undecane, and a mixture of any two or more thereof.

17. The electrolyte of claim 1, wherein the electrode stabilizing additive is a carbonate selected from the group consisting of ethylene carbonate, propylene carbonate, diethyl carbonate, dimethyl carbonate, ethyl methyl carbonate, and a mixture of two or more hereof.

18. The electrolyte of claim 17, wherein the concentration of the carbonate is 0.001 wt % to 50 wt %.

19. The electrolyte of claim 13, wherein the electrode stabilizing additive that can be oxidized or polymerized on the surface of a positive electrode is an anion receptor capable of reducing the interfacial impedance of the cell.

20. The electrolyte of claim 19, wherein the anion receptor is a borane, a boronate, or a borate.

21. The electrolyte of claim 19, wherein the anion receptor is selected from the group consisting of tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a mixture of any two or more thereof. Further suitable additives include 2-(2,4-difluorophenyl)-4-fluoro-1,3,2-benzodioxaborole, 2-(3-trifluoromethyll phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl)pentafluorophenylboronate, and a mixture of any two or more thereof.

22. The electrolyte of claim 21, wherein the anion receptor is present at a concentration of about 0.001 to about 10 wt %.

23. The electrolyte of claim 11, wherein the salt is not Li[PF₂(C₂O₄)₂] or Li[PF₄(C₂O₄)], and the electrode stabilizing additive is Li[PF₂(C₂O₄)₂], Li[PF₄(C₂O₄)], or a mixture thereof.

24. An electrochemical cell comprising the electrolyte of claim 1 and an electrode.

25. The electrochemical cell of claim 24, wherein the electrochemical cell is a lithium-ion rechargeable cell or a capacitor.
